(19) United States
(12) Patent Application Publication
(10) Pub. No.: US 2022/0243443 A1
(43) Pub. Date: Aug. 4, 2022

(54) CENTRALIZED CLEAN WATER SYSTEM

(71) Applicant: Kohler Co., Kohler, WI (US)

(72) Inventors: Shawn Booth, Sheboygan, WI (US); Lowell Lampen, Mequon, WI (US)

(21) Appl. No.: 17/577,476

(22) Filed: Jan. 18, 2022

Related U.S. Application Data
(60) Provisional application No. 63/144,678, filed on Feb. 2, 2021.

(51) Int. Cl. E03D 9/03; E03D 9/00

(52) U.S. Cl. CPC E03D 9/037; E03D 2009/024; E03D 9/002

(57) ABSTRACT

A clean water system includes at least one water tank including water, a plurality of water consuming devices coupled to the water tank, and an automatic dispenser. The automatic dispenser is configured to automatically discharge a predetermined amount of a cleaning compound into water of at least on water tank, wherein the cleaning compound is distributed to the plurality of water consuming devices.

### CROSS REFERENCE TO PRIOR APPLICATIONS

This application claims priority benefit of Provisional Application No. 63/144,678 (Docket No. 10222-20033A), filed Feb. 2, 2020, which is hereby incorporated by reference in its entirety.

### FIELD

The present application relates generally to a centralized clean water system, and more specifically, a centralized clean water system for multiple water consuming devices in a building.

### BACKGROUND

This application relates generally to the field of cleaning systems for use with toilets and accessories thereof. More specifically, this application relates to cleaning systems configured to dispense cleaning compounds for use in and around toilets, urinals, sinks, and/or other water consuming devices and accessories thereof to improve the cleanliness in and around the devices in a commercial or home environment.

Over time from use, scale (e.g., urine scale), minerals, bacteria, and other undesirable deposits (e.g., biofilm) build-up on the surfaces of toilets and, in particular, on the inner surfaces of the bowl and trapway. Moreover, these deposits may become lodged in small imperfections in the inner surfaces of the toilet, which may be a vitreous material. These built-up deposits can lead to undesirable odors and stains, as well as harbor germs and bacteria. It would be advantageous to provide a toilet having cleaning systems (e.g., internal, external) that provide improved cleanliness to address the aforementioned problems, such as prohibiting or reducing scale and/or providing odor abatement.

Additionally, external surfaces of toilets, accessories for use with toilets (e.g., toilet paper holders), and users of toilets come into contact with germs and bacteria, such as through contact with the toilet and use thereof. It would be advantageous to provide a toilet and/or accessory that includes a cleaning system to provide improved cleanliness for the toilet, accessory, and/or user.

### BRIEF DESCRIPTION OF THE DRAWINGS

Exemplary embodiments are described herein with reference to the following drawings, according to an exemplary embodiment.

FIG. 1 illustrates an example centralized cleaning system.

FIG. 2 illustrates example water consuming devices connected to the centralized cleaning system of FIG. 1.

FIGS. 3A and 3B illustrate an example distribution device for the centralized cleaning system.

FIG. 4 illustrates an example controller for the centralized cleaning system.

FIG. 5 illustrates a flow chart for the controller of FIG. 4.

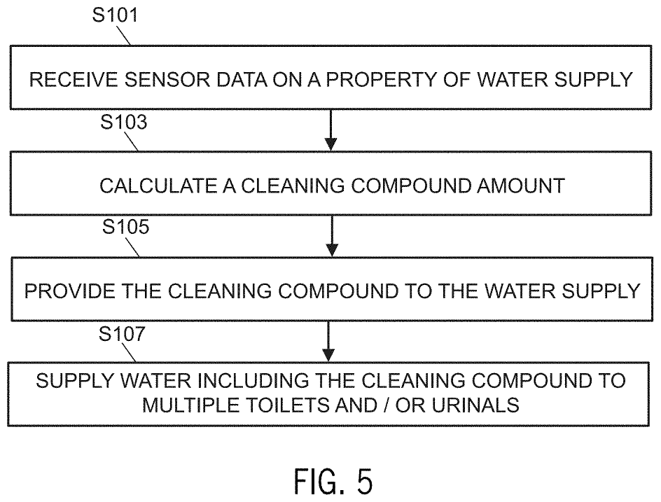

### DETAILED DESCRIPTION

Referring generally to the Figures, disclosed in this application are delivery (e.g., dispensing) systems and methods for dispensing chemicals/cleaning compounds, as part of a centralized distribution system connected to multiple devices in a bathroom or kitchen setting.

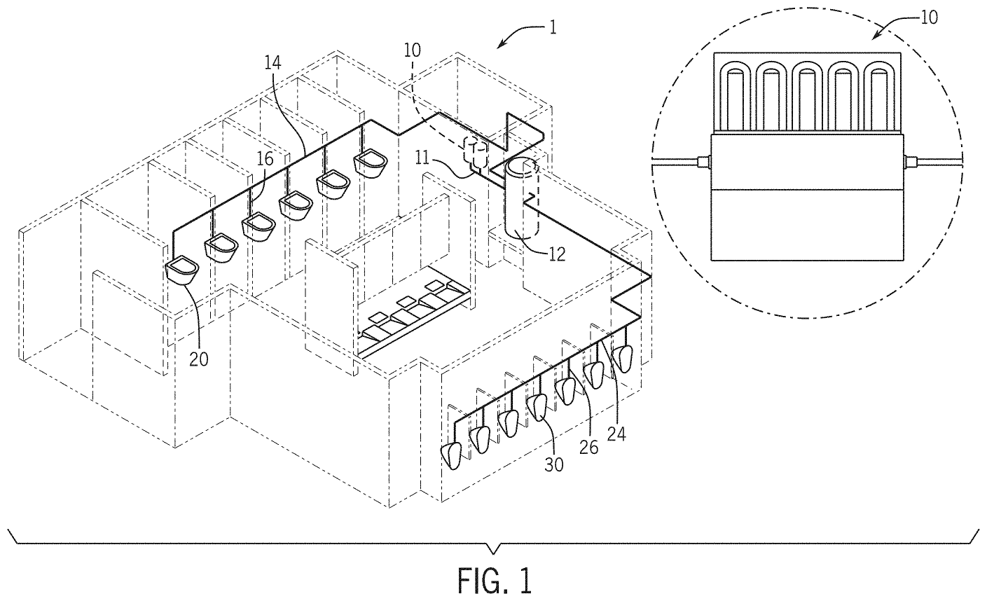

FIG. 1 illustrates an example centralized cleaning system 1. The centralized cleaning system 1 may include a dual tank distribution system including a cleaning compound tank 10 and a reservoir tank 12. The cleaning compound tank 10 and the reservoir tank 12 may combined into a single device. That is, both the cleaning compound tank 10 and the reservoir tank 12 may be coupled to the same housing or mounting apparatus. The cleaning compound tank 10 may include pucks or solutions that are distributed to the reservoir tank 12 and eventually all (or a subset of) devices connected to the plumbing system. The centralized cleaning system 1 may include a metering system 11 between the cleaning compound tank 10 and the reservoir tank 12. The metering system 11 may control the amount of cleaning compound released from the cleaning compound tank 10 to the reservoir tank 12. The volume of the cleaning compound released at an instance, according to one example may be at least 0.1 ml and not more than 100 ml. The concentration may be controlled by the volume in the mixing chamber, where the volume in the mixing chamber is at least 2 liters and not more than 200 liters. The concentration may be 0.5 ppm to 100 ppm. The concentration range may be set by an upper limit and a lower limit. The upper limit may be set by a requirement of potable water or drinking water. The lower limit may be set by a requirement for a sanitization property of the water.

Several alternative embodiments may be implemented for the metering system 11. In one example, the metering system 11 includes a fluid path between the cleaning compound tank 10 to the reservoir tank 12. The fluid path allows for the diffusion of liquid (i.e., water with the cleaning compound dissolved) therein between the cleaning compound tank 10 to the reservoir tank 12. The flow may be in the direction from the tank with the higher concentration of cleaning compound to the tank with the lower concentration of cleaning compound automatically through diffusion.

In one example, the metering system 11 includes a metering pump on the path between the cleaning compound tank 10 to the reservoir tank 12. The metering pump may pump liquid (i.e., water with the cleaning compound dissolved) therein between the cleaning compound tank 10 to the reservoir tank 12. The metering pump may be controlled by a controller or control circuit that generates a metering command or metering signal for driving the metering pump. The metering command may include data for an amount of the cleaning compound to be provided to the reservoir tank 12. The metering signal may include an amplitude or a pulse width indicative of the cleaning compound to be provided to the reservoir tank 12.

In any of these examples, integrated with the cleaning compound tank 10, or coupled to the cleaning compound tank 10, is an automatic dispenser (e.g., metering system 11) configured to automatically discharge a predetermined amount of a cleaning compound into water of at least one water tank. The cleaning compound is distributed to the water consuming devices. The automatic dispenser may dispense the cleaning compound in response to a timer. The automatic dispenser may dispense the cleaning compound in response to a sensor associated with at least one of the water consuming devices. The sensor may generate data that describes a property of the water or a surface in the device. The sensor may generate data that describes the frequency of use of the water consuming device, or more generally, for example, traffic in the bathroom.

The dual tank distribution is connected to a plumbing system connected to a few or many other devices. For example, the reservoir tank 12 may include at least one clean water output connecting water consuming devices to distribute water.

The plumbing system may include a first distribution branch 14 connected a first type of water consuming device (e.g., urinals 30) via a pipe 16 or vent that connects the distribution branch 14 to the device. The plumbing system may include a second distribution branch 24 connected a second type of water consuming device (e.g., toilets 20) via a pipe 26 or vent that connects the distribution branch 24 to the device. While FIG. 1 illustrates toilets 20 and urinals 30, it is possible for additional or alternative plumbing systems to be included to faucets, drinking water (e.g., water bottle filler or drinking fountain), as well as other devices.

In one embodiment either or both of the first distribution branch 14 and/or the second distribution branch 24 may include multiple pipes associated with different types or classes of water. That is, rather than a single pipe 16 or 26, the branch may include multiple pipes. The various pipes may be associated with different types or classes of water. For example, two pipes may be used with a first type of water flowing through a first pipe and a second type of water flowing through a second pipe. The first type of water may be hot water and the second type of water may be cold water. The first type of water may be potable water or treated water and the second type of water may be non-potable water or untreated water. In any of these examples, the cleaning compound tank 10 may be connected only to one of the multiple pipes. In the case of hot and cold water, the cleaning compound may be added only to the hot water or only to the cold water. In this way, a user (water consumer at the device) may choose between only the type of water with cleaning compound added, the type of water with cleaning compound omitted, or a mixture of the two. In the case of potable and non-potable water, the cleaning compound may be added to the pipe of the distribution system for only the non-potable water. Thus, the potable source of water is not disrupted by addition of the cleaning compound, but the water with the cleaning compound is still available at the water consuming device.

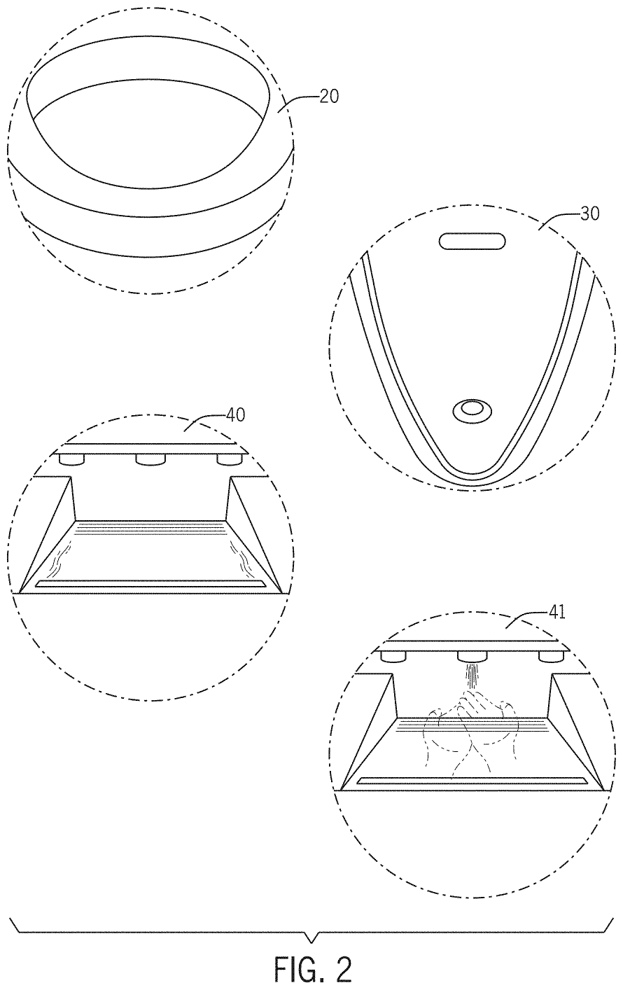

FIG. 2 illustrates examples of a urinal 30, a toilet 20, or sink 40. The water with cleaning compound may both clean the device in the case of surfaces in urinal 30, toilet 20, or sink 40 but also clean the user (e.g., handwashing) as shown in view 41.

As non-limiting examples, the systems and methods, as disclosed herein, may be configured to influence scale, slippery, and/or sanitation to thereby have improved cleanliness. For example, the systems and methods of this application may reduce scale, increase slippery, and/or increase sanitation. As used herein, the term “scale” generally refers to mineral deposits (e.g., calcium carbonate, magnesium carbonate, etc.), that collect or build-up on the surfaces of the components of systems, such as toilets. As used herein, the term “slippery” generally refers to coating(s) that may be applied to the surfaces of the components of the systems to influence the coefficient of friction of the surfaces. For example, a non-stick coating, such as a diamon-fusion coating, may be applied to surfaces of the components to reduce the coefficient of friction of the surfaces to which the coating is applied. As used herein, the term “sanitation” generally refers to the application (e.g., introduction, etc.) of anti-microbial chemicals.

One such application for the systems and methods are for use with toilets in order to provide improved cleanliness of the toilet, the area around the toilet, and/or for the user of the toilet. The centralized cleaning system 1 may be configured to include a delivery system for introducing a chemistry (e.g., a cleaning compound) to the water to thereby reduce, scale, slippery (e.g., slipperiness), and/or sanitation in the toilet or other device that uses the water. The systems and methods of this application may influence other aspects related to cleanliness or perceived cleanliness of the components. For example, scent(s) related to the systems (and the use thereof) may be influenced (e.g., masked, ameliorated, reduced, etc.) by the systems and methods of this application, such as, but not limited to the use of active filters (e.g., hydroxyl, etc.), passive filters (e.g., carbon, gas, etc.), and/or scent(s) applied to or contained within components of the system.

The cleaning compound tank 10 may be configured to utilize chemistry to advantageously help clean (e.g., up to a level just below disinfection) or help maintain the cleanliness longer than devices not having the improved chemistry. As non-limiting examples, the chemistries disclosed herein may advantageously help prevent the formation of scale, remove scale that has formed, prevent or remove biofilm, prevent or mask odors, and/or sanitize components of toilets or other devices disclosed in this application. The toilets utilizing the improved chemistry may be able to go for one to six months (e.g., eight weeks) or longer without having to be cleaned (e.g., before the build-up of deposits). More specific examples of chemistry/cleaning compounds are described below in greater detail.

The cleaning compound tank 10 may be configured to utilize one or more than one compound/chemistry to improve the cleanliness of the system. In this application, the terms “chemistry,” “compound,” and “cleaning compound” are used interchangeably to connote the use of a chemical, chemical compound, chemical element, or any combination thereof that is beyond that of mere water. Thus, while the systems described in this application may use water (e.g., to dilute a cleaning compound, for flushing, etc.) and the cleaning compounds may include water, the chemistry/compounds/cleaning compounds include at least one additional chemical (e.g., elements, compounds, etc.) other than water.

Hydrogen peroxide (H₂O₂) may be introduced into the cleaning compound tank 10. In addition to H₂O₂, chlorines and peracedic acid (PAA) are additional non-limiting examples of chemicals/compounds that may be used with the cleaning compound tank 10. Some additional non-limiting examples of chemicals/compounds that may be used with the systems and methods of this application include (but are not limited to) polyphosphates (e.g., sodium hexametaphosphate (SHMP), tetrapotassium pyrophosphate (TKPP), etc.), low pH acids (e.g., hydrogen chloride (HCL), dihydrogen phosphate (H₂PO₄), trisodium phosphate (TSP), ethylenediaminetetraacidic acid (EDTA), and compounds thereof, as well as other acids and/or sequestering agents. These chemicals/compounds may be most beneficial in, for example, preventing and/or removing scale. Yet other examples of chemicals/compounds that may be used with the systems of this application include (but are not limited to) didecyldimethyl ammonium chloride (DDAC), H₂O₂, sodium hypochlorite (NaOCl) such as bleach, PAA, triclosan, formic acid, TSP, and compounds thereof, as well as other disinfectants (e.g., quaternary disinfectants) and biocides. These chemicals/compounds may be most beneficial in, for example, preventing and/or removing biofilm. It is noted that other chemicals/compounds may be used in the systems and methods disclosed in this application, and any such chemical/compound disclosed may be used with any system and/or method disclosed.

The chemicals/compounds can take various forms, such as liquids or solids. One example is in the form of phosphate beads, which may be spherical (e.g., 1-50 mm in diameter) or may have any suitable shape. In one example, the cleaning compound is the shape of a puck or cylinder. Another example includes a shell (e.g., glass shell) that houses a chemical (e.g., phosphate) inside and is released or brought into contact with a diluent, such as through an opening. The concentration of the chemical may be relatively high, so that it can last over a long period of time (e.g., about one year) without having to be replaced. The automatic dispenser or metering system 11 dispenses the cleaning compound in response to a dissolution of a solid or liquid such as the phosphate beads or a similar material.

The cleaning compound tank 10 may include a system that generates a chemical/compound, such as one of those disclosed above. For example, a system may include a generator that produces H₂O₂, such as from oxygen (e.g., in air) and water from the reservoir tank 12 or the utility supply. Thus, a chemical/compound generator may be provided within the system, to produce the cleaning compound. According to one example, a generator may be configured to produce a chemical (e.g., H₂O₂) that is diluted to a particular range in ppm (parts per million), such as with water or other suitable diluent. According to one example, a generator is configured to produce a chemical that is diluted to a range of 2-4 ppm. In another example, the range is 1-100 ppm.

In another example, the cleaning compound tank 10 may include or be otherwise coupled to a generation system for electrolyzed water. The generation system may include an electrolyzed water reactor configured to perform electrolysis within the cleaning compound tank 10 (or an auxiliary tank) via a cathode and anode. The tank may include a separate housing that defines the reactor and includes an anode compartment for the anode and a cathode compartment for the cathode, which may be separated by a porous partition. In the anode compartment, a cleaning solution (alkaline) is produced, and in the cathode compartment, a sanitizing solution (acidic) is produced. The sanitizing solution may be a hypochlorous acid (HOCI). In some examples, an amount of sodium or another salt may be added in the water to produce the hypochlorous acid.

As a more specific example, at the cathode, hydrogen gas and hydroxide ions may be produced. At the anode, chloride ions may be oxidized into elemental chlorine. Near the cathode, the resulting alkaline solution is corrosive, and near the anode the solution includes sodium hydroxide. A sanitizing agent may be produced when hypochlorous acid without elemental chlorine is formed at around neutral pH. A neutralizing agent (e.g., vinegar) may be added to reach a target pH range.

A controller or control circuit may turn on and off an electric current to the cathode and/or the anode. The controller may provide a charge or bias to the cathode to generate the electric current between the cathode and the anode. The controller may operate a valve to add the neutralizing agent to the reactor from a neutralizing agent compartment. The sanitizing solution may be an example disinfectant provided to the bowl of the toilet 20 or other water-containing surfaces of the other devices described herein.

The cleaning compounds may also be used with other systems discussed in this application, such as standalone dispensers, paper dispenser, and so forth. Thus, these other systems may include dispensers for dispensing HOCl, H₂O₂, O₂, chlorines, PAA, and any other suitable cleaning compound, as well as any combination thereof. The systems and methods described in this application may include an electrochemical generator or method of electrochemical generation, which may involve using oxygen, water, and an electrical current to generate a chemical/compound.

A non-chemical approach to mitigating (e.g., reducing, removing, etc.) scale and other contaminants may be employed. One such example is the use of beads (e.g., flow bead), which may involve template assisted crystallization (TAC). Certain minerals (e.g., calcium, magnesium, etc.) when in an ionic form (e.g., state) may attach to surfaces (e.g., inner surface of the bowl of a toilet), but do not attach to surfaces when crystalized (i.e., in a crystalline form). The beads involving TAC change the mineral(s) from their ionic form to their crystalline form to prevent the minerals from attaching to surfaces of the systems and/or induce the in minerals to become detached from the surfaces. Thus, flow beads can utilize chemical interaction and/or friction to help clean surfaces of a system by preventing mineral deposits from attaching to the surfaces and/or knocking off mineral deposits attached to the surfaces.

Beads may be used in cleaning compound tank 10 to reduce or prohibit the build-up of scale and other contaminants on the surfaces of the toilets 20 or urinals 30. By way of example, flow beads can be used to clean a bowl, a trap, a tank, as well as other surfaces/elements of the toilet. Accordingly, beads may break up the agglomeration of scale on the inside surfaces of the components of the toilet, such as the tank, bowl, etc. By reducing the amount of scale on the surfaces of the toilet, biofilm and other contaminants have less potential of attaching to the surfaces/scale. The flow beads, therefore, may advantageously increase the slippery and/or sanitation of the toilet. Beads may be made from any suitable material that involves TAC. The beads may be blended with other materials. The beads may be configured to attach to the deposits (e.g., urine scale) on surfaces of the system to be cleaned (e.g., toilets) then crystallize to increase in size to thereby allow the bead and attached deposit to be knocked off by a fluid passing over the bead and deposit, such as from the fluidized stream of fluid flowing through the toilet or from a flow of fluid from a dispenser described in this application.

The cleaning compound tank 10 may include a cavity that houses a flow bead (“FB”) assembly that is configured to introduce one or more chemicals, compounds, or other elements from the one or more flow beads of the FB assembly into the plumbing system and ultimately the toilet 20 or urinal 30. The FB assembly includes a container for holding a volume of flow beads, an inlet for receiving a flow of fluid, such as water, and an outlet for transferring a mixture of water and chemical(s) provided by the flow beads from the container to another element of the toilet. The inlet may be fluidly connected to a water supply and the outlet connected to distribution branches 14 or 24 that are connected to the toilet 20 or urinal 30 and provide chemical(s) provided by the flow beads into the toilet bowl or urinal. Thus, the water can be a diluent of the chemical(s) provided by the flow beads and/or a carrier of the chemical(s), as well as aid in flushing the contents from the bowl of the toilet 20 or urinal 30.

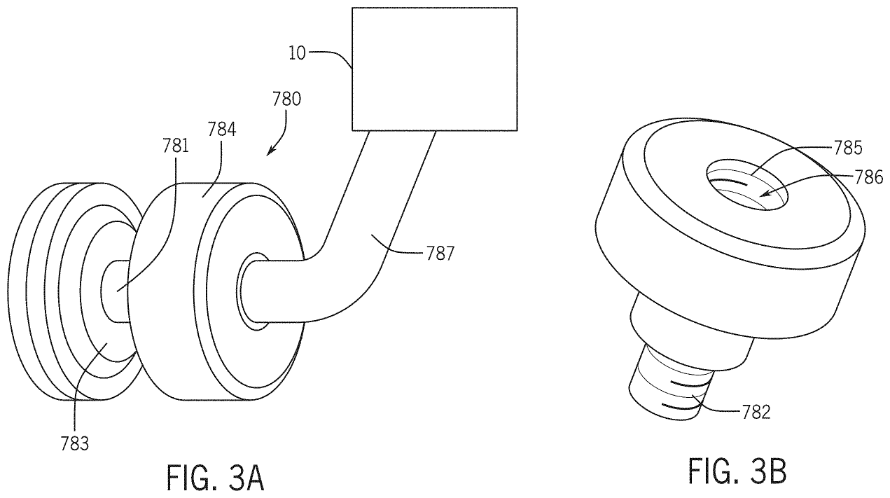

FIGS. 3A and 3B illustrate another exemplary embodiment of a FB assembly 780 for use in-line with a water line 781, such as a water inlet, of the cleaning compound tank 10. The FB assembly 780 includes a hollow inlet connector 782 configured to connect to a water line connector 783. The inlet connector 782 is configured to receive water from the water line 781. As shown, the inlet connector 782 includes external threads that mate with internal threads in a bore of the water line connector 783. A passage in the inlet connector 782 fluidly connects the water inlet connector 783 with a mixing chamber in the FB assembly 780. The FB assembly 780 includes a container 784 for housing flow beads, which are configured to be mixed with water in the mixing chamber. The FB assembly 780 includes an outlet connector 785 including a bore 786 having internal threads that mate with external threads of an outlet line 787 to fluidly connect the outlet of the FB assembly 780 with another element of the toilet, such as a tank (e.g., fill valve) or a bowl through the outlet line 787.

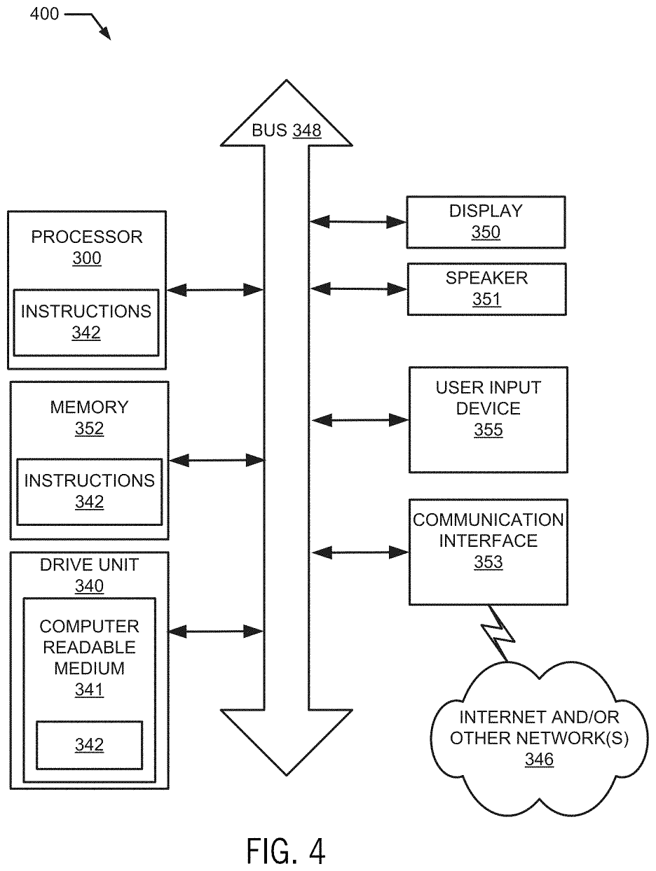

The cleaning compound tank 10 may include a pump or other suitable device configured to move the compound through the plumbing system, such as from the cleaning compound tank 10 to the reservoir tank 12. The cleaning compound tank 10 may include an electronic controller (e.g., controller 400 of FIG. 4) configured to control dispensing of the system. The electronic controller may include a printed circuit board (PCB) having a microprocessor, such as to communicate with and control other electronic elements of the system. The controller may be in electronic communication, either wired or wireless communication, with any sensor, any pump, and/or any other electrical/electronic elements/components of the system. For example, the controller may receive a signal output from the sensor indicating a concentration of cleaning solution or a property of the water.

The cleaning compound tank 10 may include an external or internal power source, such as a battery that is configured to supply electric power to the system, such as any sensor, any pump, any controller, or any other electronic component. Thus, the power source may be electrically connected to (e.g., in electric connection with) other any other electronic component of the system.

The cleaning compound tank 10 may include an automatic dispensing system including a peristaltic pump, a sensor, a chemical storage device, and a dispenser. The sensor is configured to control operation of the pump, such as upon a detection activity. The sensor may include any type of sensor described in this application. The chemical storage device is configured to store (e.g., house) a chemical/cleaning compound, such as any chemical/compound disclosed herein. The storage device may be a container (e.g., bottle) or any other suitable device, and the size (e.g., volume) of the device may be of any suitable size. The peristaltic pump is configured to pump the chemical/compound from the storage device to the dispenser. The peristaltic pump may be configured according to any known arrangement and may be of any suitable size. The dispenser is configured to dispense or discharge the chemical/compound and may be configured according to any dispenser described herein.

The touchless dispensing system may include a hose (e.g., fluid conduit, tube, etc.) connecting the peristaltic pump to another component. A first hose (e.g., supply hose) fluidly connects the storage device and the peristaltic pump, and a second hose (e.g., delivery hose) fluidly connects the peristaltic pump and the dispenser.

The systems described in this application may employ sensing at the toilet 20 or urinal 30, such as to detect certain actions and/or to provide functionality (e.g., dispensing, flushing, etc.). Odor sensors, proximity sensors, and motion sensors are non-limiting examples of sensors that may be included. Odor sensors, such as volatile organic compound (VOC) sensors, may be employed to detect organic chemicals and compounds, both human made and naturally occurring chemicals/compounds. Proximity sensors may be employed to detect the presence of an object within a zone of detection without physical contact between the object and the sensor. Electric potential sensors (e.g., Plessey epic sensors), low capacity sensors (e.g., ultra-low capacity), capacitance sensors, projected capacitance sensors, and infrared sensors (e.g., projected infrared sensors, passive infrared sensors) are non-limiting examples of proximity sensors that may be employed. Motion sensors may be employed to detect motion (e.g., a change in position of an object relative to the objects surroundings). Electric potential sensors (e.g., Plessey epic sensors), optic sensors, radio-frequency (RF) sensors, sound sensors, magnetic sensors (e.g., magnetometers), vibration sensors, and infrared sensors (e.g., projected infrared sensors, passive infrared sensors) are non-limiting examples of motion sensors that may be employed with the systems described herein.

The toilet 20 or urinal 30 may include a controller in communication with the sensor and/or the dispensing system. For example, the sensor may be configured to emit a signal (e.g., wireless) upon detection of an object/activity to the controller. The signal may indicate to the controller the type of object/activity, such as, for example, any one of or combination of the examples noted above. The controller may then control other systems of the toilet, such as the dispensing system, based on the indicated objects/activities by the signal from the sensor. For example, the controller may control a flush cycle (e.g., low volume flush, high volume flush, etc.), dispensing of one or more cleaning compounds from any number of dispensing systems (e.g., the dispensing system or any other system), or other suitable systems of the toilet 20 or urinal 30.

The systems/assemblies (e.g., toilets) described in this application may be configured to monitor and/or control (e.g., abate) odors from the systems/assemblies. The systems/assemblies may employ chemicals/compounds (e.g., zeolite, charcoal, air hydroxyl, H₂O₂, etc.), ventilation devices, a combination of chemicals/compounds and ventilation devices, or other suitable elements to abate odors.

As noted above, the systems/assemblies described in this application may include sensors or other sensing devices that are configured to detect odor(s), such as to initiate a system to abate the odor(s). Odor sensors may be included on or in the toilets, on or in standalone systems, or on or in other systems that may benefit from having an odor sensor. As non-limiting examples, VOC sensors may be employed to detect organic chemicals and compounds, which may be human made or naturally occurring, within the systems/assemblies of this application. For example, a VOC sensor may be disposed in a seat assembly (e.g., at the underside of the seat) of a toilet to detect odors in and around the bowl of the toilet. Also, for example, a VOC sensor may be disposed in the bowl of the toilet to detect odors in and around the bowl of the toilet. These types of sensors may take a reactive approach in odor abatement by first detecting the presence of an odor before taking steps to counter the odor.

Other types of sensors may be provided that take a proactive approach to odor abatement. For example, a proximity sensor may be employed to detect the presence of a user and initiate dispensing of a chemical/compound to counter odor before the odor is even detectable by the user and/or sensor. The proximity sensor may be configured as any system having a sensor described in this application. Proximity sensors may also be used to provide a reactive approach to odor abatement.

As noted above, ventilation systems may be employed to help abate odors in the systems/assemblies. The ventilation systems may employ a filtering material, such as a zeolite, charcoal, hydroxyl (e.g., air hydroxyl), H₂O₂, or other suitable material. The ventilation systems may be used in toilets, such as within the tanks of toilets. The ventilation systems may be dual cycle systems, such as providing an odor abatement cycle and a drying cycle.

The toilet may include a sensor disposed in the mixing chamber that measures the concentration of the cleaning compound and communicates the measured concentration to the controller. The controller may communicate wirelessly the concentration of the cleaning compound to a remote smart device. The toilet may include an indicator comprising a light source, where the light source is illuminated by a signal from the controller based on the concentration of the cleaning compound. The toilet may include a battery disposed in the toilet, where the battery is configured to provide electric power to the controller, sensor and the indicator. The controller may communicate wirelessly at least one of the concentration of the cleaning compound or a life of the battery to a remote smart device. The moveable member of the flush valve may be a float, where the valve body engages an opening in the tank and an opening in the bowl. The flush valve may include a guide member, which may be fixed to the valve body for guiding movement of the float relative to the valve body, where the guide member includes an internal chamber configured to receive the cleaning compound.

According to another embodiment, a toilet may be provided that is configured to be connected to a water supply. The toilet includes a dispensing system and a structure that includes at least one of a tank or a bowl. The dispensing system is coupled to the structure, and the dispensing system includes a reservoir located in the structure and configured to hold a volume of a chemical compound, and a dispenser configured to discharge a predetermined amount of the chemical compound upon activation. The chemical compound may be a solid that dissolves in water from the water supply in the reservoir. The chemical compound may be a liquid.

FIG. 4 illustrates a flow chart for the control system 400. The cleaning compound tank 10 may include, or otherwise be coupled with, an electronic controller (e.g., controller 400 of FIG. 4) configured to control dispensing. Thus, the controller 400 is an automatic dispenser configured to automatically discharge a predetermined amount (based on time or water usage, e.g.) of a cleaning compound into water of at least one water tank. Further, the controller 400 may send commands to a separate automatic dispenser that is connected to the cleaning compound tank 10.

The acts of the flow chart may be performed by any combination of the control system 400, the network device or the server. Portions of one or more acts may be performed by the appliance. Additional, different of fewer acts may be included.

At act S101, the controller 400 (e.g., through processor 300 include instructions 342) receives data regarding a water supply. The data may be sensor data collected in one or more of various locations.

In one example, the sensor is associated with at least one of the water consuming devices such as toilets 20, urinals 30, and sinks 40. The sensor at the water consuming device may be a flow sensor configured to detect a flow of water from the at least one water tank to the water consuming devices. The flow sensor may alternatively be located with the at least one water tank and/or one or more pipes of the water distribution system.

In one example, the sensor is associated with a concentration of the cleaning compound in the water. The sensor configured to detect the concentration of the cleaning compound may be located in the at least one water tank. The sensor configured to detect the concentration of the cleaning compound may be located in one or more of the water consuming devices. The sensor configured to detect the concentration of the cleaning compound may be located in a distribution branch pipe coupled to the water consuming devices.

The concentration sensor may include a sonic transmitter and receiver configured to measure the speed of an ultrasonic signal or wave through the water in the cleaning system. The controller 400 may calculate the concentration of the cleaning compound because speed of the ultrasonic signal varies as a function of the concentration of the cleaning compound.

The concentration sensor may include a density meter that measures density of the water. The controller 400 may calculate the concentration of the cleaning compound because density varies as a function of the concentration of the cleaning compound.

The concentration sensor may include an electrical conductivity sensor that measures the electrical conductivity (ability to transport ionic charges) of the water. The electrical conductivity sensor may include a first coil that generates a current through the water and a second coil that measures the current. The controller 400 may calculate the concentration of the cleaning compound because current varies as a function of the concentration of the cleaning compound.

Other techniques such as pH, spectroscopy, radiometry, and/or refractometry may be used by the concentration sensor.

The data may be timer data. That is, the controller 400 may include or otherwise implement a timer, and the automatic dispenser dispenses the cleaning compound in response to the timer. Example time periods for causing the cleaning compound to be dispensed may be once a minute, once an hour, once a day, or another time period. The time period or interval may be selected by the user. The time period or interval may be determined based on the traffic in the facility.

At act S103, the controller 400 (e.g., through processor 300) calculates a cleaning compound amount or the release of the cleaning compounds in response to the data for the water supply. When the sensor is a flow sensor, the controller 400 may calculate the cleaning compound amount based on the total amount of water that has flowed to the water consuming devices or the amount of water that has flowed from the at least one water tank. In other words, the controller 400 compares a value for the cumulative flow of water to a threshold value. For example, the controller 400 may trigger a predetermined amount of cleaning compound when the threshold flow is surpassed by the cleaning system.

When the sensor is a concentration sensor, the controller 400 may calculate the cleaning compound amount based on the concentration of the cleaning compound in the water that has flowed to the water consuming devices or the concentration of the cleaning compound in the water that is stored in the at least one water tank. In other words, the controller 400 compares a value for the current concentration of the water to a threshold value. For example, the controller 400 may trigger a predetermined amount of cleaning compound when the concentration of the water flow falls below the threshold.

In another embodiment, the cleaning compound amount is a predetermined amount released based on timing alone.

The user input device 355 may include a control panel or another device configured to receiving one or more settings from a user. The user may be a maintenance personnel that maintains the centralized cleaning system 1. The input device 355 may include a switch (e.g., actuator), a touchscreen coupled to or integrated with, a keyboard, a remote, a microphone for voice inputs, a camera for gesture inputs, and/or another mechanism.

The one or more settings may include a concentration setting. That is, the user provides a concentration input to the user input device 355, which the controller 400 compares to the sensor data from the concentration sensor to determine whether the dispenser should add cleaning compound to the tank.

The one or more settings may include a shutoff command. That is, the user provides a shutoff requests to the user input device 355. In response to the shutoff request, the controller 400 may stop dispensing of the cleaning compound.

At act S105, the cleaning compound is provided to a tank coupled to a plurality of bathroom devices. At act S107, water including the cleaning compound is supplied to a plurality bathroom devices (e.g., toilets 20 and urinals 30).

In another example, act S103 may be modified such that the controller 400 determines a type or property of the cleaning compound and the amount of the cleaning compound calculated in act S103 depends on the type of the cleaning compound. The type of the cleaning compound may be the chemical itself (i.e., chlorine is one type of cleaning compound and hydrogen peroxide is another type of cleaning compound). The type of cleaning compound may be whether it is an additive to the system or generated within the system (e.g., electrolyzed water). The property of the cleaning compound may be acidity or pH (i.e., more acidic cleaning compounds may be used in smaller amounts).

The type or property of the cleaning compound may be determined by a sensor. The type or property of the cleaning compound may be entered by the user to the user input device 355. The type or property may be stored in memory 352 (e.g., as data or instructions 342 implementable by the processor 300), or in addition or the alternative a concentration corresponding to the type or property is stored in the memory 352. The memory 352 may be reset when new cleaning compound is added or the system is otherwise reset by the user. The controller 400 is configured to access a concentration setting for the determined type or property of the cleaning compound, and the amount of cleaning compound is calculated based on the concentration setting.

In some embodiments, the controller 400 may additionally monitor the supply of the cleaning compound and generate a message in response to the supply of the cleaning compound. In other words, when new cleaning compound is released into the water tank or into the distribution system, the controller 400 may generate a message including data indicative of the cleaning compound. The message may be provided to the user via display 350 or speaker 351. The display 350 may include a screen or a light emitting diode. The message may indicate only that cleaning compound is being dispensed (e.g., light flash) or the message may indicate the type of cleaning compound and/or the amount of cleaning compound that is being dispensed. The message may indicate whether the water in the water consuming device (e.g., sink 40) is safe for drinking and/or safe for handwashing.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, memory 298 may include graphics, web pages, HTML files, XML files, script code, shower configuration files, or other resources for use in generating graphical user interfaces for display and/or for use in interpreting user interface inputs to make command, control, or communication decisions.

Optionally, the control system 410 may include a drive unit 340 for receiving and reading non-transitory computer media 341 having instructions 342. Additional, different, or fewer components may be included.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

What is claimed is:

1. A clean water system comprising:
at least one water tank configured to hold water;
a plurality of water consuming devices coupled to the at least one water tank; and
an automatic dispenser configured to automatically discharge a predetermined amount of a cleaning compound into water of the at least one water tank, wherein the cleaning compound is distributed to the plurality of water consuming devices.

2. The clean water system of claim 1, wherein the automatic dispenser dispenses the cleaning compound in response to a timer.

3. The clean water system of claim 1, wherein the automatic dispenser dispenses the cleaning compound in response to a dissolution of a solid.

4. The clean water system of claim 1, wherein the automatic dispenser dispenses the cleaning compound in response to a sensor.

5. The clean water system of claim 4, wherein the sensor is associated with at least one of the plurality of water consuming devices.

6. The clean water system of claim 4, wherein the sensor is configured to detect a flow of water from the at least one water tank to the plurality of water consuming devices.

7. The clean water system of claim 4, wherein the sensor is associated with a concentration of the cleaning compound in the water.

8. The clean water system of claim 7, wherein the sensor is configured to detect the concentration of the cleaning compound in the at least one water tank.

9. The clean water system of claim 8, wherein the sensor is configured to detect the concentration of the cleaning compound in a distribution branch pipe coupled to the plurality of water consuming devices.

10. The clean water system of claim 1, further comprising:
a control panel configured to receiving one or more settings from a user.

11. The clean water system of claim 10, wherein the one or more settings includes a concentration setting.

12. The clean water system of claim 10, wherein the one or more settings includes a shutoff command.

13. A method for operation of a clean water system, the method comprising:
receiving sensor data for the clean water system;
calculating an amount of a cleaning compound in response to the sensor data;
providing the cleaning compound to a water supply; and
supplying the water supply including the cleaning compound.

14. The method of claim 13, further comprising:
determining a type or property of the cleaning compound in response to the sensor data; and
accessing a concentration setting for the determined type or property of the cleaning compound, wherein the amount of cleaning compound is calculated based on the concentration setting.

15. The method of claim 13, wherein the sensor data includes at least one value for a flow of water for a plurality of water consuming devices connected to the clean water system.

16. The method of claim 13, further comprising:
monitoring a supply of the cleaning compound; and
generating a message in response to a supply of the cleaning compound.

17. A clean water apparatus including:
at least one clean water output connecting to at least one water tank configured to distribute water to a plurality of water consuming devices coupled to the at least one water tank; and
an automatic dispenser configured to automatically discharge an amount of a cleaning compound into water of the at least on water tank, wherein the cleaning compound is distributed to the plurality of water consuming devices.

18. The clean water apparatus of claim 17, further comprising:
a sensor configured to detect a concentration of cleaning compound in the at least one water tank.

19. The clean water apparatus of claim 18, further comprising:
a controller configured to analyze sensor data from the sensor and calculate the amount of the cleaning compound in response to the sensor data.

20. The clean water apparatus of claim 19, wherein the controller is configured to determine a type of at least one of the plurality of water consuming devices and the amount of the cleaning compound is based in part on the type of the at least one of the plurality of water consuming devices.
